(19) United States
(12) Patent Application Publication
(10) Pub. No.: US 2018/0202215 A1
(43) Pub. Date: Jul. 19, 2018

(54) PINCHING DETECTION DEVICE

(71) Applicant: KABUSHIKI KAISHA TOKAI RIKA DENKI SEISAKUSHO, Aichi (JP)

(72) Inventor: Tatsushi KATSUYAMA, Aichi (JP)

(73) Assignee: Kabushiki Kaisha Tokai Rika Denki Seisakusho, Aichi (JP)

(21) Appl. No.: 15/743,736

(22) PCT Filed: Jul. 11, 2016
(86) PCT No.: PCT/JP2016/070370

§ 371 Date: Jan. 11, 2018

(30) Foreign Application Priority Data
Aug. 4, 2015 (JP) 2015-153901

(51) Int. Cl. E05F 15/46; E05F 15/695; B60J 1/17

(52) U.S. Cl. CPC E05F 15/46; E05F 15/695; E05Y 2201/434; E05Y 2900/55; E05Y 2900/531; B60J 1/17

(57) ABSTRACT

An entrapment detection device, which detects entrapment caused by an opening/closing movement of an opening/closing body, includes a conductive member arranged on an edge of the opening/closing body. The entrapment detection device also includes a sensor electrode arranged inside the opening/closing body. The sensor electrode is opposed to the conductive member. The entrapment detection device further includes a detection unit that detects entrapment between the opening/closing body and an external member based on a change in capacitance of the sensor electrode.

### TECHNICAL FIELD

The present invention relates to an entrapment detection device.

### BACKGROUND ART

Patent document 1 discloses an entrapment detection device including an electrode that configures part of an electrostatic sensor and is arranged on a door window, which is one example of an opening/closing body. The entrapment detection device uses the electrostatic sensor to detect entrapment. When the electrostatic sensor detects entrapment as the door window closes, the movement of the door window is reversed. This releases an entrapped subject from the door window.

### PRIOR ART DOCUMENT

Patent Document 1: Japanese Laid-Open Patent Publication No. 2005-314949

### SUMMARY OF THE INVENTION

### Problems that are to be Solved by the Invention

In Patent Document 1, the electrode is arranged along an upper edge of the door window. In this configuration, the electrode is exposed to the outside. Thus, a portion of the electrode may be broken due to deterioration or the like resulting from weathering or wear caused by contact between the electrode and a glass run when the window closes. In such a case, a detection unit, which detects entrapment, cannot detect entrapment at the electrode portion that is disconnected from the detection unit, which detects entrapment. Therefore, the durability of the entrapment detection device is insufficient.

It is an object of the present invention to provide an entrapment detection device having high durability.

### Means for Solving the Problem

According to one aspect, an entrapment detection device that detects entrapment caused by an opening/closing movement of an opening/closing body is provided. The entrapment detection device includes a conductive member arranged on an edge of the opening/closing body, a sensor electrode arranged inside the opening/closing body, and a detection unit that detects entrapment between the opening/closing body and an external member based on a change in capacitance of the sensor electrode. The sensor electrode is opposed to the conductive member.

In this configuration, the sensor electrode is arranged inside the opening/closing body. Thus, the sensor electrode does not slide on the external member and is not exposed to the ambient climate. This prevents breakage of parts of the sensor electrode and improves the durability of the entrapment detection device.

Further, in this configuration, the conductive member is arranged on an edge of the opening/closing body. Thus, when entrapment of a subject occurs during the opening/closing movement of an opening/closing body, a capacitor, in which the conductive member where the entrapment subject contacts and the sensor electrode function as an electrode, is formed with ground. This increases the opposing surface area of the electrodes compared to when a capacitor, in which the entrapment subject and the sensor electrode function as an electrode, is formed with ground, thereby increasing changes in capacitance. This improves the entrapment detection accuracy of the detection unit.

### Effect of the Invention

The present invention improves the durability of the entrapment detection device.

### BRIEF DESCRIPTION OF THE DRAWINGS

FIG. 1 is a schematic view illustrating an entrapment detection device applied to a power window.

FIG. 2A is a cross-sectional view illustrating a surface that is orthogonal to a direction in which the window glass opens/closes, and FIG. 2B is a cross-sectional view illustrating a surface that is orthogonal to a thickness direction of the window glass.

FIG. 3 is a cross-sectional view illustrating a surface that is orthogonal to a direction in which the window glass opens/closes according to another embodiment.

### EMBODIMENTS OF THE INVENTION

One embodiment of an entrapment detection device will now be described. The entrapment detection device of the present example is applied to a vehicle power window, which is one example of an opening/closing controller.

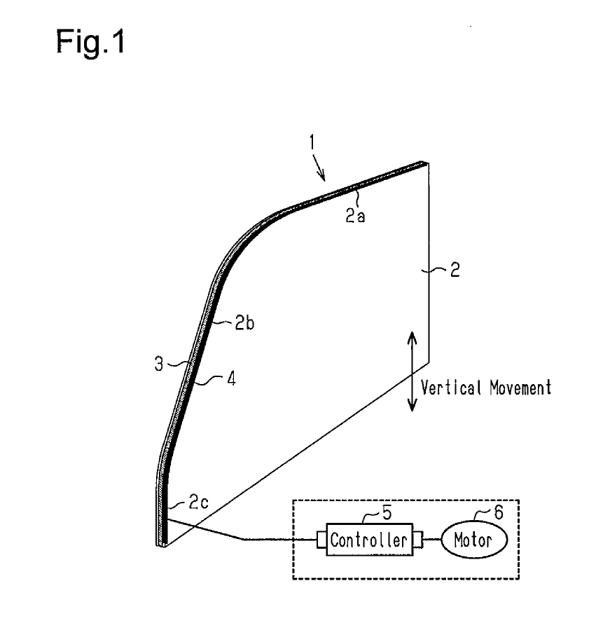

As illustrated in FIG. 1, a power window 1 includes a window glass 2, a contact electrode 3, a sensor electrode 4, a controller 5, and a motor 6.

The window glass 2 corresponds to an opening/closing body and is driven by the motor 6 to move in the vertical direction while sliding in a window frame (external member, not illustrated). The opening movement of the window glass 2 is defined by a lowering movement of the window glass 2, and the closing movement of the window glass 2 is defined by a lifting movement of the window glass 2.

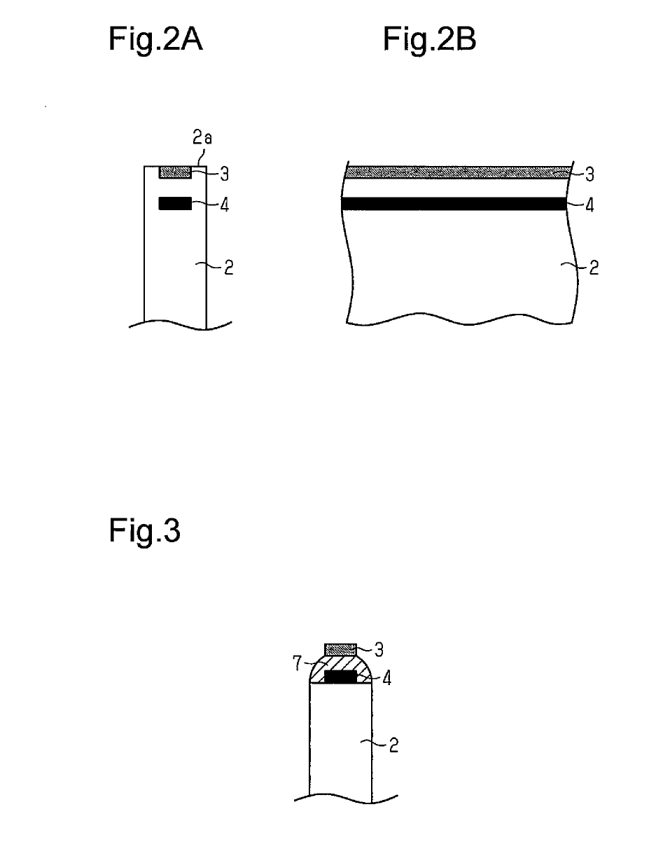

As illustrated in FIG. 1, FIG. 2A, and FIG. 2B, the contact electrode 3 is arranged on an upper end surface 2a, an inclined end surface 2b that is continuous with the front side of the upper end surface 2a, and a side end surface 2c that is continuous with the front side of the inclined end surface 2b among end surfaces of the planar window glass 2. Since the window glass 2 is a nonconductive member, the contact electrode 3 is not electrically connected to other members. Therefore, the contact electrode 3 is not energized. The contact electrode 3 is allowed to contact a window frame (not illustrated) when the window glass 2 reaches the fully-closed position. The contact electrode 3 corresponds to a conductive member. Also, in this example, the upper end surface 2a, the inclined end surface 2b, and the side end surface 2c correspond to edges located at the same side with respect to the closing direction of the opening/closing body. In this example, the contact electrode 3 is flush with the end surfaces 2a to 2c (only end surface 2a illustrated in FIG. 2A) of the window glass 2, or the edge of the opening/closing body. That is, the contact electrode 3 is arranged on the same level as the end surfaces 2a to 2c. In this configuration, the sides of the contact electrode 3 are covered by the window glass 2. This limits breakage of the contact electrode 3 in a preferred manner.

The sensor electrode 4 is arranged inside the window glass 2 along the upper end surface 2a, the inclined end surface 2b, and the side end surface 2c of the window glass 2. That is, the sensor electrode 4 is opposed to the entire contact electrode 3.

As illustrated in FIG. 1, the controller 5 is electrically connected to the sensor electrode 4, the motor 6, and an operation switch (not illustrated) that undergoes an operation input for starting the opening or closing movement of the window glass 2. The controller 5 corresponds to the detection unit.

When acknowledging an operation input to the operation switch, the controller 5 drives the motor 6 to open or close the window glass 2.

The opening operation and the closing operation of the window glass 2 each include a manual operation that stops movement of the window glass 2 when the operation switch is released and an automatic operation that continues movement of the window glass 2 until the window glass 2 reaches a fully-open position or a fully-closed position even if the operation switch is released. In the automatic operation, an operation for continuing the lowering movement of the window glass 2 until the window glass 2 reaches the fully-open position is referred to as the “automatic down operation,” and an operation for continuing a lifting movement of the window glass 2 until the window glass 2 reaches the fully-closed position is referred to as the “automatic up operation.”

The controller 5 constantly monitors changes in capacitance of the sensor electrode 4. For example, when the controller 5 detects an increase in capacitance of the sensor electrode 4 during a lifting movement of the window glass 2 that is started by an automatic up operation, the controller 5 reverses movement of the window glass 2, that is, lowers the window glass 2. This releases an entrapped subject such as a finger from the window glass 2.

### Operation

The operation of the power window 1 will now be described. In the capacitor, when the dielectric constant of the dielectric is represented by E, the electrode opposing area is represented by S, and the distance between the electrodes is represented by d, capacitance C of the capacitor can be obtained from the following known equation (1):

C=ϵ×S/d (1)

As illustrated in the above equation, the capacitance C is proportional to the electrode opposing area S.

In this embodiment, the contact electrode 3 is arranged over the upper end surface 2a, the inclined end surface 2b, and the side end surface 2c of the window glass 2. Therefore, a capacitor, in which the contact electrode 3 and the sensor electrode 4 function as an electrode, is formed with ground even when an entrapment subject such as a finger contacts any of the upper end surface 2a, the inclined end surface 2b, and the side end surface 2c of the window glass 2. The entire contact electrode 3 is opposed to the entire sensor electrode 4. Accordingly, when employing the contact electrode 3 like in the present embodiment, the opposing area S is enlarged thereby increasing the capacitor C as compared with when the contact electrode 3 is omitted, that is, when a capacitor of which the electrode is the entrapment subject and the sensor electrode 4 is connected to ground.

The sensor electrode 4 is arranged inside the window glass 2. Thus, the sensor electrode 4 does not slide on the external member and not exposed to the ambient climate because the window glass 2 isolates the sensor electrode 4 from the external environment.

It is preferred that the sensor electrode 4 be arranged in the vicinity of the contact electrode 3. This limits obstruction of the field of view due by the sensor electrode 4 when the window glass 2 is in the fully-closed position.

As described above, the present embodiment has the following advantages.

(1) The contact electrode 3 is arranged over the upper end surface 2a, the inclined end surface 2b, and the side end surface 2c of the window glass 2. In addition, the sensor electrode 4 is arranged inside the window glass 2. The sensor electrode 4 is opposed to the entire contact electrode 3. In this configuration, when an entrapment subject such as a finger contacts the contact electrode 3, the opposing area S of the contact electrode 3 and the sensor electrode 4 increases. This increases the capacitance C. That is, the change in capacitance C between a case in which the entrapment subject contacts the contact electrode 3 and a case in which the entrapment subject does not contact the contact electrode 3 becomes large. Thus, the detection unit 5 can easily detect whether or not an entrapment has occurred. This easily avoids a state in which the subject is entrapped between the window glass 2 and the window frame.

The sensor electrode 4 is arranged inside the window glass 2. Thus, the sensor electrode 4 does not slide on the window frame and the like and is not exposed to the ambient climate. This prevents breakage of parts of the sensor electrode and improves the durability of the function for preventing entrapment in the power window 1.

(2) The contact electrode 3 is continuously extended over the upper end surface 2a, the inclined end surface 2b, and the side end surface 2c of the window glass 2. This obtains a larger opposing area S with respect to the sensor electrode 4 than when separate electrodes are used for each of the upper end surface 2a, the inclined end surface 2b, and the side end surface 2c of the window glass 2. Thus, the change in capacitance C is large when an entrapment subject contacts the contact electrode 3 than when the entrapment subject does not contact the contact electrode 3. Thus, the detection unit 5 can easily detect whether or not an entrapment has occurred.

(3) The contact electrode 3 and the sensor electrode 4 are proximate to each other. This increases the amount of change in capacitance C between a case in which the entrapment subject contacts the contact electrode 3 and a case in which the entrapment subject does not contact the contact electrode 3. This also ensures the field of view through the window glass 2 without affecting the aesthetic appeal.

The above embodiment may be modified as described below.

In the above embodiment, the contact electrode 3 and the sensor electrode 4 are both arranged in the window glass 2. However, the contact electrode 3 and the sensor electrode 4 may be arranged as described below.

As illustrated in FIG. 3, the sensor electrode 4 is arranged on an edge of the window glass 2, and the edge is covered with a nonconductive material 7 such as silica. This covers the entire sensor electrode 4. Then, the contact electrode 3 is arranged on the nonconductive material 7. The contact electrode 3 is opposed to the sensor electrode 4. This arrangement has the following advantages in addition to the advantages of the above embodiment. This arrangement is obtained by the steps of arranging the sensor electrode 4 on the outer side of the window glass 2, arranging the nonconductive material 7 on the outer side of the sensor electrode 4, and arranging the contact electrode 3 on the outer side of the nonconductive material 7. This eliminates the step of inserting the sensor electrode 4 into the window glass 2 and facilitates manufacturing. In the modified example of FIG. 3, the window glass 2 corresponds to an opening/closing main body and the combination of the window glass 2 and the nonconductive material 7 corresponds to an opening/closing body. In this configuration, the sensor electrode 4 is arranged on the edge of the window glass 2 that corresponds to the edge of the opening/closing main body, and the contact electrode 3 (conductive member) is arranged on the edge of the nonconductive material 7 that corresponds to the edge of the opening/closing body.

In the above embodiment, when the controller 5 detects an increase in capacitance of the sensor electrode 4 during the lifting movement of the window glass 2 started by an automatic up operation, the controller 5 lowers the window glass 2 to release an entrapped subject. The lowering movement is not limited to cases in which the lifting movement of the window glass 2 is started as an automatic up operation. For example, the controller 5 can lower the window glass 2 to release an entrapped subject when detecting an increase in the capacitance of the sensor electrode 4 during a lifting movement of the window glass 2 started as a manual operation.

Further, the window glass 2 does not necessarily have to be lowered. That is, the controller 5 may be configured to stop the lifting movement of the window glass 2 regardless of whether it is an automatic operation or a manual operation if an increase in the capacitance of the sensor electrode 4 is detected during the lifting movement of the window glass 2. This prevents the entrapped subject from being caught in the window glass 2.

In the above embodiment, the contact electrode 3 and the sensor electrode 4 need only be a conductive material. It is preferable that the contact electrode 3 be formed from a material having superior wear resistance such as a conductive rubber.

In the above embodiment, the contact electrode 3 is a single member arranged over the entire edge of the window glass 2 at the closing direction side. The contact electrode 3 may be divided into a plurality of members. The contact electrode 3 does not have to be arranged on all of the end surfaces 2a to 2c. For example, the contact electrode 3 may be arranged on the end surfaces 2a and 2b.

In the above embodiment, the entrapment detection device is applied to the power window 1 in which the window glass 2 of the vehicle serves as the opening/closing body. The entrapment detection device may also be applied to opening/closing bodies such as those that will now be described. The opening/closing body may be a shutter or the like of a building in which an opening movement is defined by a lifting movement and a closing movement is defined by a lowering movement. Further, the opening/closing body may be a swinging door in which the opening/closing movement is defined by a swinging movement. The opening/closing body may also be a sliding door of a vehicle or an automatic door of a building in which the opening/closing movement is defined by movement in a horizontal direction.

1. An entrapment detection device that detects entrapment caused by an opening/closing movement of an opening/closing body, the entrapment detection device comprising:
a conductive member arranged on an edge of the opening/closing body;
a sensor electrode arranged inside the opening/closing body, the sensor electrode being opposed to the conductive member; and
a detection unit that detects entrapment between the opening/closing body and an external member based on a change in capacitance of the sensor electrode.

2. The entrapment detection device according to claim 1, wherein
the conductive member is a single member arranged over an entire edge of the opening/closing body at a side in a closing direction, and
the sensor electrode is opposed to the entire conductive member.

3. The entrapment detection device according to claim 1, wherein the conductive member is flush with the edge of the opening/closing body.

4. The entrapment detection device according to claim 1, wherein:
the opening/closing body includes
an opening/closing main body, and
a nonconductive material arranged on the opening/closing main body;
the sensor electrode is located on an edge of the opening/closing main body; and
the conductive member is located on an edge of the nonconductive material.
